(19) United States
(12) Patent Application Publication
(10) Pub. No.: US 2026/0303584 A1
(43) Pub. Date: Oct. 1, 2026

(54) CONTEXT-BASED CONNECTION POLICIES FOR SECURING REMOTE VIRTUAL DEVICE CONNECTIONS

(71) Applicant: Microsoft Technology Licensing, LLC, Redmond, WA (US)

(72) Inventors: Shilei LIU, Suzhou (CN); Jie LIU, Bellevue, WA (US); Xiangyi DENG, Suzhou (CN); Na LI, Bellevue, WA (US); Lavanya KASARABADA, Woodinville, WA (US); Yizhong WU, Shanghai (CN); Jun SHI, Redmond, WA (US)

(21) Appl. No.: 19/573,193

(22) Filed: Mar. 20, 2026

Related U.S. Application Data
(63) Continuation of application No. PCT/CN2025/086079, filed on Mar. 31, 2025.

(51) Int. Cl. H04L 9/40

(52) U.S. Cl. CPC H04L 63/08

(57) ABSTRACT

Methods, apparatuses, and products for context-based connection policies for securing remote virtual device connections, including: receiving, from a client device, a request to establish a session with a virtual computing device implemented in a cloud computing environment, wherein the request comprises an authentication context received by the client device from an authentication service, wherein the authentication context describes a user account associated with the client device and an operational state of the client device; establishing the session between the client device and the virtual computing device; and controlling one or more redirection features of the session based on the authentication context.

### CROSS REFERENCE TO RELATED APPLICATION

This is a continuation application for patent under 35 U.S.C. §§120 and 365(c), claiming the benefit of earlier-filed International Application No. PCT/CN2025/086079, filed March 31, 2025, herein incorporated by reference in its entirety.

### BACKGROUND

Cloud computing platforms allow for pools of shared computing resources to support virtual computing devices, such as virtual machines or virtual personal computers (PCs). Organizations may use virtual computing devices as part of their infrastructure, such that users can remotely connect to these virtual computing devices using other devices, including personal devices. In order to protect organizational data, security measures may be implemented at the client device and/or the virtual computing device.

In some existing implementations, security for accessing remote virtual computing devices may be enforced at the client device accessing the remote virtual computing device. For example, remote device management may be used to control what features or functions are available in sessions with remote virtual computing devices. This requires that the client device have remote device management software installed, limiting which devices are able to connect to the remote virtual computing device.

In some other existing implementations, security for accessing remote virtual computing devices may be enforced at the virtual computing device itself. For example, some virtual computing devices such as virtual machines inherit the configuration and settings of a container image. In these implementations, the security features for sessions with the virtual computing device are defined in the container image. Using these approaches, any changes to these security settings must be made at the container image, requiring any virtual computing devices based on the image to be reprovisioned so as to reflect these changes. Accordingly, there remains a need for improved techniques for enforcing security policies in remote virtual computing environments that provide flexibility and efficiency without being constrained by client device restrictions or container-based provisioning requirements.

### SUMMARY

According to embodiments of the present disclosure, various methods, apparatus, and products for context-based connection policies for securing remote virtual device connections are described herein. In some aspects, context-based connection policies for securing remote virtual device connections include: receiving, from a client device, a request to establish a session with a virtual computing device implemented in a cloud computing environment, wherein the request comprises an authentication context received by the client device from an authentication service, wherein the authentication context describes a user account associated with the client device and an operational state of the client device; establishing the session between the client device and the virtual computing device; and controlling one or more redirection features of the session based on the authentication context. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a diagram of an example system for context-based connection policies for securing remote virtual device connections in accordance with some embodiments.

FIG. 2 sets forth a flow chart illustrating an example method of context-based connection policies for securing remote virtual device connections in accordance with some embodiments.

FIG. 3 sets forth a flow chart illustrating an additional example method of context-based connection policies for securing remote virtual device connections in accordance with some embodiments.

FIG. 4 sets forth a flow chart illustrating an additional example method of context-based connection policies for securing remote virtual device connections in accordance with some embodiments.

FIG. 5 sets forth a flow chart illustrating an additional example method of context-based connection policies for securing remote virtual device connections in accordance with some embodiments.

FIG. 6 sets forth a flow chart illustrating an additional example method of context-based connection policies for securing remote virtual device connections in accordance with some embodiments.

FIG. 7 illustrates an exemplary computing device that may be specifically configured to perform one or more of the processes described in the present disclosure.

FIG. 8 sets forth a block diagram of a cloud service provider service architecture in accordance with some embodiments of the present disclosure.

### DESCRIPTION OF EMBODIMENTS

Cloud computing platforms allow for pools of shared computing resources to support virtual computing devices, such as virtual machines or virtual personal computers (PCs). Organizations may use virtual computing devices as part of their infrastructure, such that users can remotely connect to these virtual computing devices using other devices, including personal devices. In order to protect organizational data, security measures may be implemented at the client device and/or the virtual computing device.

Existing approaches for security in remotely-accessed virtual computing devices may be enforced at the client device or the virtual device. For example, remote device management may be used to push application-level security configurations to managed devices for enforcement. This requires the client device connecting to the virtual computing device to have remote device management features installed, limiting the usable devices that may access the virtual computing device. Additionally, device-level enforcement requires device- or platform-specific software. Moreover, this may not provide adequate security against malicious device administrators. As another example, security can be enforced at a virtual machine host pool whereby every virtual machine created from a particular container inherits those settings. Using these solutions, in order to change the security settings of a virtual machine, the settings of the original container must be updated and any virtual machines based on this container must be reprovisioned to reflect these changes.

To address these shortcomings, among other benefits, the approaches set forth herein provide a system for enforcing security for remotely accessed virtual computing devices. A client device may authenticate with an authentication service. The authentication service determines whether the client device matches an administrator-defined authentication context based on the operational state of the client device and/or the user accessing the client device. The client device may then receive the authentication context from the authentication service and include it in a request to establish a session with a virtual computing device. Redirection features of the virtual computing device are controlled based on a connection policy mapped to the authentication context.

The disclosed approaches provide a technical solution for dynamically enforcing security policies in cloud-based virtual computing environments without requiring client-side management or extensive reprovisioning of virtual computing devices. By leveraging an authentication context determined at session establishment, security restrictions can be applied in real time without modifying the underlying virtual machine configuration or requiring changes to the container or host system. This reduces the computational overhead associated with security policy enforcement and enhances system scalability by allowing security settings to be updated and applied dynamically without downtime or manual intervention. Additionally, because security enforcement is decoupled from both the client device and the underlying virtual infrastructure, the solution provides improved resistance to unauthorized modifications by malicious client-side actors while maintaining compatibility across a broad range of devices.

Cloud-based virtual computing devices empower users to access organizational infrastructure remotely. Securing access to these virtual computing devices is essential to protect the integrity of organizational data. The approaches set forth herein provide for greater flexibility and security than existing approaches reliant on client-side enforcement or that require significant reprovisioning of cloud-based resources to update security. By reducing the need for manual security updates and eliminating the overhead associated with reprovisioning virtual computing devices, organizations can lower operational costs and minimize downtime. Additionally, the ability to dynamically enforce security policies at session establishment enhances compliance with regulatory requirements related to data security and access control. The increased flexibility in client device compatibility broadens the potential user base, enabling enterprises to support a wider range of employee and contractor devices without compromising security. Furthermore, by providing a seamless and adaptive security framework, the disclosed approaches improve user experience and adoption rates, leading to greater productivity.

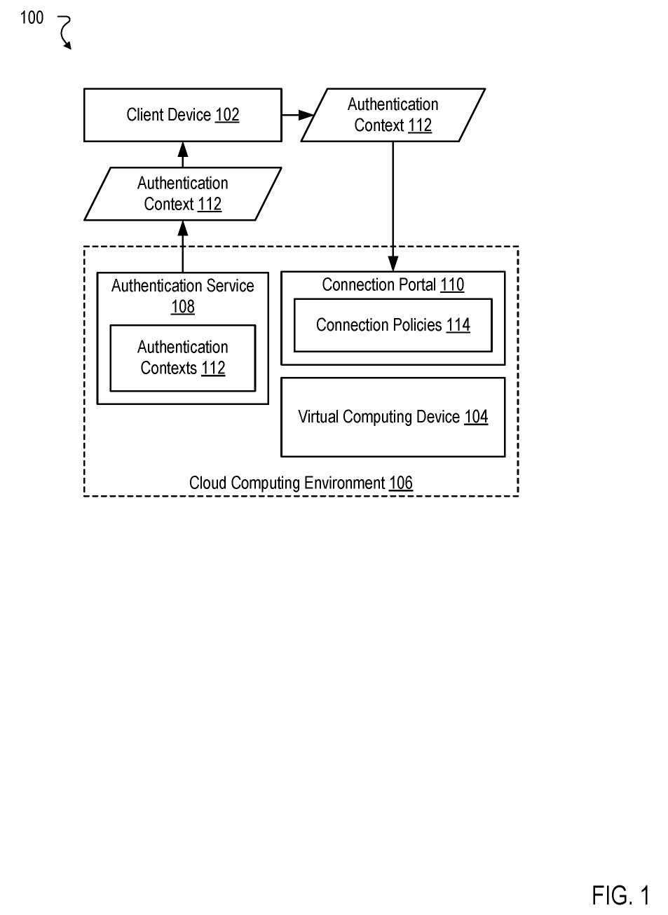

To begin, FIG. 1 shows a diagram of an example system 100 for context-based connection policies for securing remote virtual device connections in accordance with some embodiments of the present disclosure. In the example system 100 of FIG. 1, a client device 102 is configured to establish a session with a virtual computing device 104 implemented in a cloud computing environment 106. The client device 102 may include any type of computing device such as a personal computer, a mobile device, or another computing device as can be appreciated. The cloud computing environment 106 includes a set of hardware and software resources that allow for the creation and management of cloud-based computing resources. For example, the cloud computing environment 106 may support a particular cloud computing platform for creating and managing these cloud-based computing resources.

The virtual computing device 104 is a virtualized instance or simulation of a computing device implemented as software in the cloud computing environment 106. In some embodiments, the virtual computing device 104 may include a virtual machine, a virtual PC, a virtual desktop environment, or another virtual computing device 104 as can be appreciated. A session between the client device 102 and the virtual computing device 104 allows for a user of the client device 102 to access and interact with the virtual computing device 104 remotely via the session. In other words, the session between the client device 102 and the virtual computing device 104 allows a user to connect to and control the virtual computing device 104 using the client device 102 as a remote device.

To create the session between the virtual computing device 104 and the client device 102, the client device 102 first authenticates with an authentication service 108. The authentication service 108 is a service that authenticates and manages identities for one or more other systems, including the connection portal 110 as described below. For example, the authentication service 108 may perform various tasks including verifying authentication credentials, controlling access to resources or functionality of some systems, or other tasks as can be appreciated.

In some embodiments, the client device 102 may provide a request to the authentication service 108 to authenticate the client device 102. In some embodiments, the request may include authentication credentials such as username(s), password(s), token(s), key(s), or other authentication credential(s) that serve to verify the identity of a user of the client device 102. In some embodiments, the request may include data uniquely identifying the client device 102, such as a media access control (MAC) address or another machine identifier. In some embodiments, the request may include data or metadata indicating a network connection accessed by the client device 102. In some embodiments, the request may include data describing software or applications installed on the client device 102, including a particular operating system, software used to establish and manage a session with the virtual computing device 104, remote device management software, and the like. The request to authenticate the client device 102 may also include other information as can be appreciated.

The authentication service 108 then verifies the client device 102 using the provided authentication credentials. The client device 102 is successfully authenticated in response to the authentication credentials being valid and associated with a valid user identity. In some embodiments, in response to a successful authentication, the authentication service 108 determines whether the client device 102 is associated with a predefined authentication context 112. An authentication context 112 is a set of rules or criteria that may be satisfied by the client device 102. If the client device 102 matches the rules or criteria of an authentication context 112, the authentication service 108 provides, to the client device 102, the authentication context 112 (e.g., data indicating the authentication context 112 matched by the client device 102). In some embodiments, the authentication context 112 may include an administrator-defined or other user-defined authentication context 112. For example, in some embodiments, an administrator may define, in the authentication service 108, one or more authentication contexts 112.

In some embodiments, the rules or criteria of an authentication context 112 may correspond to a user account associated with the client device 102. In other words, in some embodiments, the authentication context 112 may indicate or describe a user account associated with the client device 102. In some embodiments, the authentication context 112 may indicate or describe a user account logged into the client device 102 or whose authentication credentials were provided to the authentication service 108. In some embodiments, the authentication context 112 may indicate or describe a specific user account associated with the client device 102 or a user group including a user account associated with the client device 102. Accordingly, in some embodiments, the authentication service 108 may determine, in response to a successful authentication of the client device 102, whether a user account associated with the client device 102 matches a user account or user group identified in an authentication context 112.

In some embodiments, the rules or criteria of an authentication context 112 may correspond to or describe an operational state of the client device 102. For example, in some embodiments, the rules or criteria of an authentication context 112 may indicate whether the client device 102 is a managed device. A managed device is a device that has remote device management software installed that enables monitoring, management, and/or control of the client device 102 remotely. As another example, in some embodiments, the rules or criteria of an authentication context 112 may indicate whether the client device 102 is using a trusted network connection. A trusted network connection is a connection from the client device 102 to one or more predefined networks and/or a network meeting certain criteria for trusted networks. For example, in some embodiments, a trusted network connection may include a virtual private network (VPN) connection for a particular organization (e.g., associated with the virtual computing device 104 or another organization). Put differently, an authentication context 112 may describe a client device 102 authenticating with the authentication service 108 across multiple dimensions, including a user account or group, whether or not the client device 102 is a managed device, and whether or not the client device 102 is using a trusted network connection. Readers will appreciate that, in some embodiments, an authentication context 112 may describe a client device 102 using other attributes or dimensions.

Accordingly, in some embodiments, the authentication service 108 may access data included in the authentication request from the client device 102, and/or other data, to determine whether the operational state of the device matches any defined authentication context 112. For example, in some embodiments, the client device 102 may provide, to the authentication service 108, data indicating the network connection of the client device 102 and/or data indicating whether the client device 102 is a managed device. As another example, in some embodiments, the authentication service 108 may use a machine identifier for the client device 102 to access data storing machine identifiers of known managed devices.

As is set forth above, in response to a successful authentication, the authentication service 108 determines if the client device 102 matches any defined authentication context 112. If so, the authentication service 108 provides the authentication context 112 to the client device 102. In other words, the authentication service 108 provides, as the authentication context 112, data describing the particular conditions satisfied by the client device 102. In some embodiments, the authentication context 112 may be provided to the client device 102 as a token, a hash value, or other data indicating the particular authentication context 112 matched by the client device 102. In some embodiments, the authentication service 108 may also provide other data to the client device 102 indicating a successful authentication, such as a token or other data as can be appreciated.

As an example, assume that a client device 102 successfully authenticates with the authentication service 108 using an unmanaged device connected to a trusted network connection using a user account included in a security team user group. Further assume that an authentication context 112 has been defined for unmanaged devices and security team members. In this example, the authentication service 108 will return this authentication context 112 to the client device 102, in some cases along with other data indicating a successful authentication. As another example, assume that an authentication context 112 has been defined for unmanaged devices and untrusted network connections. In this example, the authentication context 112 will not be returned as the client device 102 does not match the criteria of using an untrusted network connection. Readers will appreciate that, in some embodiments, a client device 102 may potentially match multiple defined authentication contexts 112.

The client device 102 then provides, in a request to establish a session with a virtual computing device 104, any authentication context 112 received from the authentication service 108 to a connection portal 110 (e.g., in addition to any other data indicating a successful authentication). The connection portal 110 is an interface accessible to client device(s) 102 that establishes and manages remote connections to virtual computing device(s) 104. In some embodiments, the connection portal 110 will use the provided authentication context 112 to determine how to control redirection features of the session using a connection policy 114. A connection policy 114 describes the particular redirection features that will be allowed or forbidden in a session between a client device 102 and a virtual computing device 104. In some embodiments, a connection policy 114 may enumerate each redirection feature and indicate whether that feature is allowed or forbidden. In some embodiments, a connection policy 114 may indicate a subset of available redirection features and indicate whether they are allowed or forbidden. Accordingly, in some embodiments, a redirection feature not specifically indicated as being allowed or forbidden in a connection policy may be implicitly allowed or forbidden by omission.

Redirection features are features that, when enabled in a session between a client device 102 and a virtual computing device 104, allow for a resource of one device to be shared with and accessed by the other device. In some embodiments, a redirection feature may include clipboard redirection. Using clipboard redirection, a clipboard (e.g., a temporary storage area for cut or copied data) can be shared between the client device 102 and the virtual computing device 104, thereby allowing for data to be cut or copied from one device and pasted to the other. For example, a user may open a document on the virtual computing device 104 and copy or cut text into the clipboard. The user can then paste this data from the clipboard into a file or input field on the client device 102. Thus, data is redirected between the client device 102 and the virtual computing device 104 using the clipboard.

In some embodiments, a redirection feature may include print redirection. Using print redirection, a printer coupled or accessible to one device (e.g., the client device 102) may be used by the other device (e.g., the virtual computing device 104) for printing. For example, a user may open a document on the virtual computing device 104 and print that document using a printer accessible to the client device 102. In some embodiments, print redirection may be considered a type of device redirection where some device coupled or accessible to one device (e.g., a printer) is usable by another device. Accordingly, in some embodiments, a redirection feature may include other types of device redirection. In some embodiments, device redirection may be defined with respect to a particular device or type of device, such as a printer, a camera, or the like. In some embodiments, device redirection may be defined with respect to a particular device interface such as Universal Serial Bus (USB) redirection, thereby enabling sharing of any device coupled to that interface.

In some embodiments, a redirection feature may include file redirection. Using file redirection, a file on one device can be uploaded or downloaded to another device. For example, a file stored on a client device 102 can be uploaded to the virtual computing device 104, or a file stored on the virtual computing device 104 can be downloaded to the client device 102. In some embodiments, file redirection may include upload redirection and download redirection as separate redirection features. In some embodiments, upload redirection may include transferring files from the client device 102 to the virtual computing device 104, while download redirection may include transferring files from the virtual computing device 104 to the client device 102. In some embodiments, upload redirection may be assigned one permission (e.g., allowed or forbidden) while download redirection may be assigned a different permission. In some embodiments, upload redirection and download redirection may be treated as the same file redirection feature having the same assigned permissions.

As with authentication contexts 112, the connection policies 114 may be administrator-defined or otherwise user-defined. Particularly, connection policies 114 may be mapped to authentication contexts 112 (e.g., by an administrator or other user) such that, when provided with an authentication context 112 from a client device 102, the mapped connection policy 114 is accessed by the connection portal 110. The connection portal 110 then establishes the session between the client device 102 and the virtual computing device 104, controlling the particular redirection features available in that session as described in the connection policy 114. For example, a connection policy 114 may indicate that print redirection is allowed, that clipboard redirection is not allowed, and the like.

In some embodiments, a client device 102 may not match any defined authentication context 112. In such embodiments, the request from the client device 102 to establish the session with the virtual computing device 104 may omit an authentication context 112. Accordingly, the connection portal 110 cannot load any mapped connection policy 114. In some embodiments, the connection portal 110 may apply a default connection policy 114. For example, the connection portal 110 may allow or forbid certain or all redirection features in absence of an authentication context 112 mapped to a connection policy 114.

In order to enforce particular restrictions or permissions on redirection features for certain sessions, an administrator or other user may create (e.g., in the authentication service 108) an authentication context 112 describing the particular criteria or rules to which client devices 102 are subject. The administrator may then create, in the connection portal 110, a connection policy 114 describing these restrictions or permissions. The administrator may then map the created authentication context 112 to the created connection policy 114 such that sessions with that authentication context 112 will be subject to the mapped connection policy 114.

As an example, assume that an administrator wishes to prevent security team members having unmanaged client devices 102 from using clipboard redirection. In this example, the administrator may create an authentication context 112 indicating a security team user group and an unmanaged client device 102. The administrator may also create a connection policy 114 that prevents clipboard redirection and may map that connection policy 114 to the previously described authentication context 112. A security team member using an unmanaged client device 102 will receive this authentication context 112 from the authentication service 108 upon authentication. The connection portal 110 will receive this authentication context 112 from the client device 102 when establishing a session and load the mapped connection policy 114. As the mapped connection policy 114 prevents clipboard redirection, the client device 102 will be unable to use clipboard redirection during a session with the virtual computing device 104.

In some embodiments, a given connection policy 114 can be mapped to multiple authentication contexts 112. Thus, in some embodiments, multiple different authentication contexts 112 may be subject to the same restrictions defined in the same connection policy 114. In some embodiments, a client device 102 may match multiple authentication contexts 112. In such embodiments, the client device 102 may receive, from the authentication service 108, and provide, to the connection portal 110, these multiple authentication contexts 112. Where these multiple authentication contexts 112 are mapped to different connection policies 114, the client device 102 may be subject to multiple connection policies 114. In some embodiments, a contradiction in connection policies 114 may occur where a particular redirection feature is allowed under one connection policy 114 and forbidden under another connection policy 114. Accordingly, in some embodiments, contradicting permissions for a particular redirection feature across multiple applicable connection policies 114 may be resolved by determining whether to forbid or allow the particular redirection feature. In some embodiments, resolving contradicting permissions for a particular redirection feature may default to forbidding the particular redirection feature or allowing the particular redirection feature. In some embodiments, contradicting permissions for a particular redirection feature may be resolved according to other approaches.

Although the approaches set forth herein are described with respect to redirection features, in some embodiments, other features of a session between a client device 102 and virtual computing device 104 may also be controlled according to similar approaches. For example, a connection policy 114 may indicate whether features other than or in addition to redirection features are allowed in sessions subject to that connection policy 114. Such features may include, for example, displaying watermarks in an interface rendered on the client device 102 for accessing the virtual computing device 104, key logging, key capture, or other features as can be appreciated.

Readers will appreciate that the approaches set forth herein enable security for redirection features using defined authentication contexts 112 and mapped connection policies 114. This provides several advantages over existing implementations. For example, some existing implementations rely on application-level security implemented at the client device 102 using remote device management. Though this may provide some redirection security features, it does not account for the potential of malicious device administrators and is limited to managed client devices 102. In contrast, the approaches described herein allow for connection policies 114 to be defined for client devices 102 using multiple dimensions, including a user account or group, whether or not the client device 102 is a managed device, and whether or not the client device 102 is using a trusted network connection.

As another example, some existing implementations rely on defining permissions for redirection features in the container used to create virtual machine instances (e.g., as virtual computing devices 104). In these implementations, to change these permissions, the settings in the container must be updated and any virtual machines derived from that container must be reprovisioned. In contrast, using the approaches set forth herein, redirection feature permissions may be changed by updating an existing connection policy 114, creating and mapping a new connection policy to an authentication context 112, creating a new authentication context 112, and the like, thereby allowing for redirection feature permissions to change without reprovisioning the virtual computing devices 104.

As a further example, some existing implementations require that client devices 102 meet certain criteria in order to connect to a virtual computing device 104. For example, only managed client devices 102 that are connected to a trusted network may be allowed to connect to a virtual computing device 104. In these implementations, a client device 102 is either compliant or non-compliant with respect to these criteria, making the ability for a client device 102 to connect to a virtual computing device 104 a binary decision. In contrast, the approaches set forth herein allow for differing levels of restriction for client devices 102 using different authentication contexts 112 and connection policies 114. This may allow for client devices 102 that are not fully compliant according to some criteria to still access virtual computing devices 104 subject to some restrictions in their allowable redirection features.

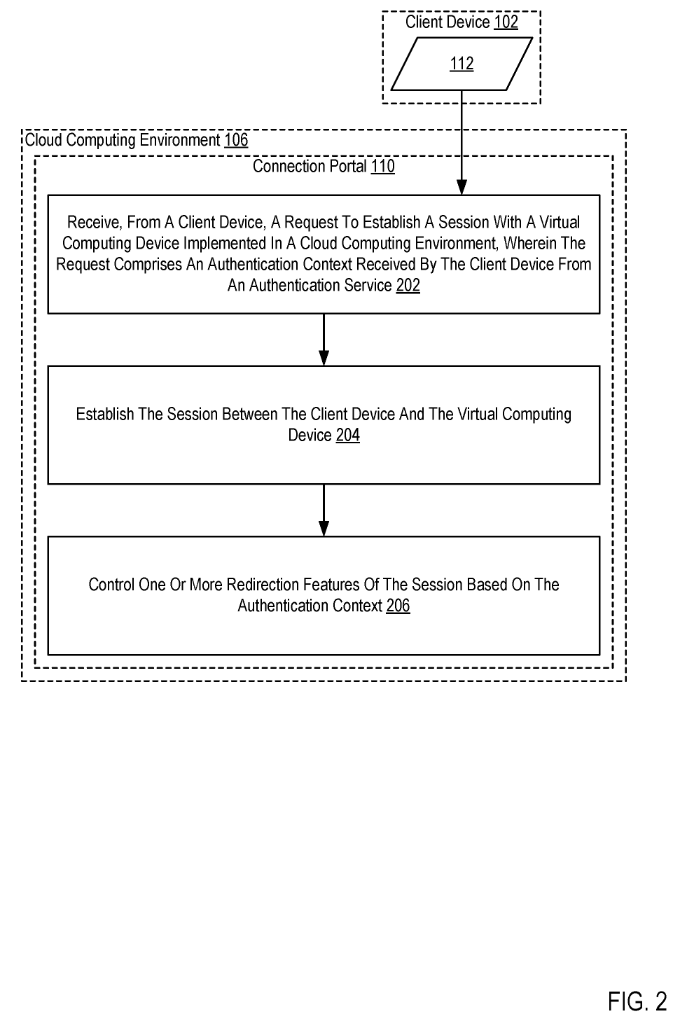

For further explanation, FIG. 2 sets forth a flowchart of an example method of context-based connection policies for securing remote virtual device connections in accordance with some embodiments of the present disclosure. The method of FIG. 2 may be performed, for example, by a connection portal 110 in a cloud computing environment 106 of FIG. 1. The method of FIG. 2 includes receiving 202, from a client device 102, a request to establish a session with a virtual computing device 104 implemented in a cloud computing environment 106, wherein the request comprises an authentication context 112 received by the client device 102 from an authentication service 108. As described herein, an authentication context 112 describes various attributes of the client device 102 that will establish the session with the virtual computing device 104. For example, the authentication context 112 may indicate a particular user logged into the client device 102 or authenticated with the authentication service 108, a user group including such a user, whether the client device 102 is a managed device, whether the client device 102 is using a trusted network connection, or other information as can be appreciated. In some embodiments, the request to establish the session may include other information in addition to the authentication context 112, such as data indicating a successful authentication with the authentication service 108, such as a token or other data as can be appreciated. In some embodiments, the authentication context 112 itself may serve as data indicating a successful authentication with the authentication service 108.

The method of FIG. 2 also includes establishing 204 the session between the client device 102 and the virtual computing device 104. The session between the client device 102 and the virtual computing device 104 allows the client device 102 to access and control the virtual computing device 104. As the authentication context 112 serves as or is included with data indicating a successful authentication of the client device 102, the connection portal 110 may allow the session to be established. This may include, for example, presenting a virtual desktop environment or other interface on the client device 102 that accepts user inputs directed toward the virtual computing device 104.

The method of FIG. 2 also includes controlling 206 one or more redirection features of the session based on the authentication context 112. During the session between the client device 102 and the virtual computing device 104, one or more redirection features may be controlled based on the authentication context 112. In other words, one or more redirection features may be allowed or forbidden based on the authentication context 112 received from the client device 102. Such redirection features may include, for example, clipboard redirection, print redirection, and/or file redirection. As will be described in further detail below, the particular redirection features that are allowed and/or forbidden may be defined in a connection policy 114 mapped to the authentication context 112. Thus, rather than relying on application-level security implemented at the client device 102 or security settings inherited from a container image, the one or more redirection features are controlled based on the particular authentication context 112 of a client device 102 accessing the virtual computing device 104 via the session.

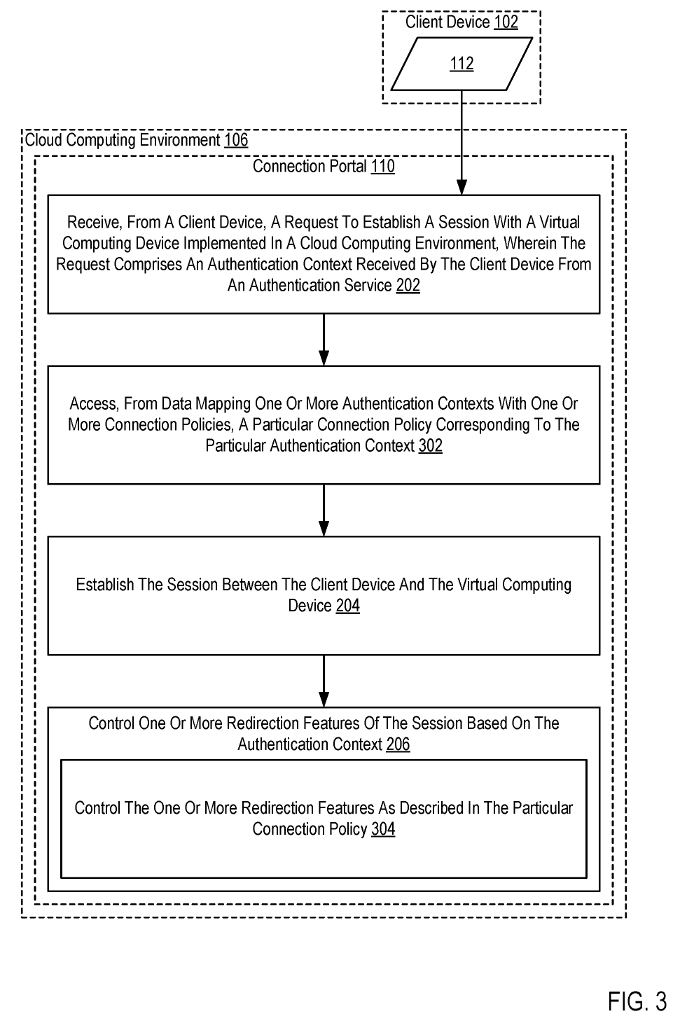

For further explanation, FIG. 3 sets forth a flowchart of another example method of context-based connection policies for securing remote virtual device connections in accordance with some embodiments of the present disclosure. The method of FIG. 3 is similar to FIG. 2, differing in that the method of FIG. 3 also includes accessing 302, from data mapping the one or more authentication contexts 112 with one or more connection policies 114, a particular connection policy 114 corresponding to the particular authentication context 112. In some embodiments, a connection policy 114 defines, for one or more redirection features, whether those features are allowed or forbidden in a session between a client device 102 and virtual computing device 104 subject to the connection policy 114. In some embodiments, each connection policy 114 may include an administrator-defined or other user-defined connection policy 114.

In some embodiments, one or more of the connection policies 114 may be mapped to one or more authentication contexts 112. For example, an administrator or other user may map a particular connection policy 114 to a particular authentication context 112 such that the particular connection policy 114 will be applied to sessions matching the authentication context 112. Accordingly, in response to receiving the authentication context 112 from the client device 102, the connection portal 110 may access the data mapping connection policies 114 to authentication contexts 112 to identify the connection policy 114 mapped to the received authentication context 112.

The method of FIG. 3 further differs from FIG. 2 in that controlling 206 one or more redirection features of the session based on the authentication context 112 also includes controlling 304 the one or more redirection features of the session as described in the particular connection policy 114. Thus, the particular redirection features allowed or forbidden in the session between the client device 102 and the virtual computing device 104 are defined in a connection policy 114 mapped to an authentication context 112 received from the client device 102 and provided to the connection portal 110.

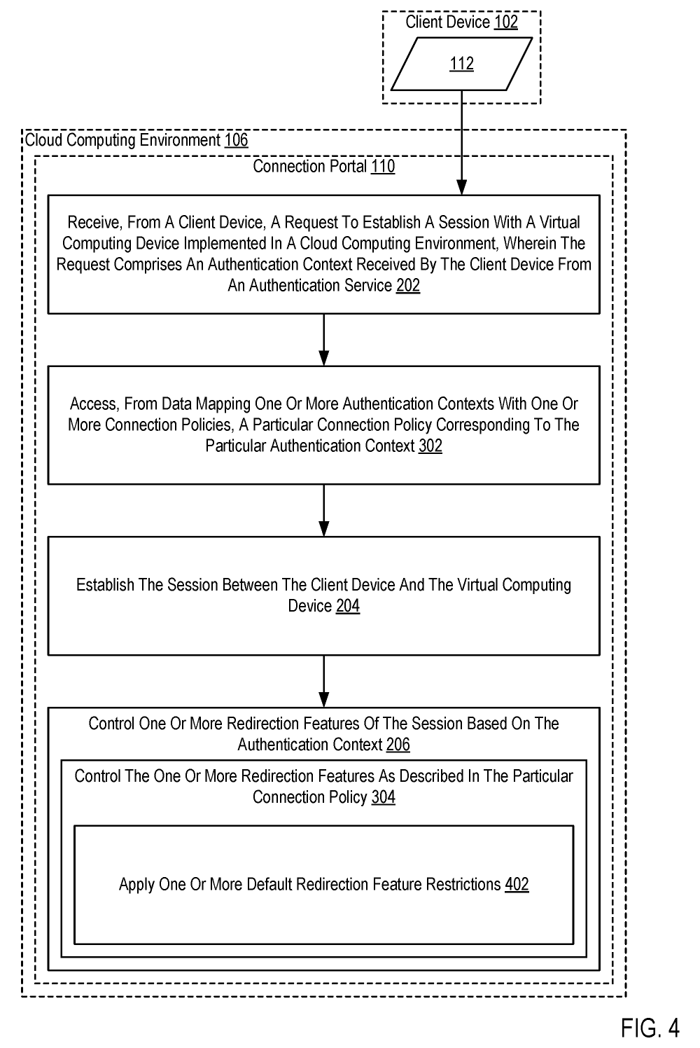

For further explanation, FIG. 4 sets forth a flowchart of another example method of context-based connection policies for securing remote virtual device connections in accordance with some embodiments of the present disclosure. The method of FIG. 4 is similar to FIG. 3, differing in that controlling 304 the one or more redirection features of the session as described in the particular connection policy 114 also includes applying 402 one or more default redirection feature restrictions. In some embodiments, a connection policy 114 may not specifically enumerate each redirection feature that can be allowed or forbidden for a session. Accordingly, in some embodiments, a connection policy 114 may omit one or more redirection features. In some embodiments, these omitted redirection features may have a default restriction (e.g., allowed or forbidden). Thus, where a connection policy 114 of a session does not specifically indicate the restrictions for a particular redirection feature, the default restriction for that redirection feature may be applied. In some embodiments, the same default redirection feature restriction may be applied to any omitted redirection feature. For example, in some embodiments, any omitted redirection feature defaults to being forbidden. This may be used, for example, to prevent redirection features from being unintentionally permitted due to their omission from a connection policy 114, thereby potentially exposing the virtual computing device 104 or organizational data. As another example, in some embodiments, any omitted redirection feature defaults to being allowed. In some embodiments, each redirection feature may have its own default redirection feature restriction that may vary across different redirection features.

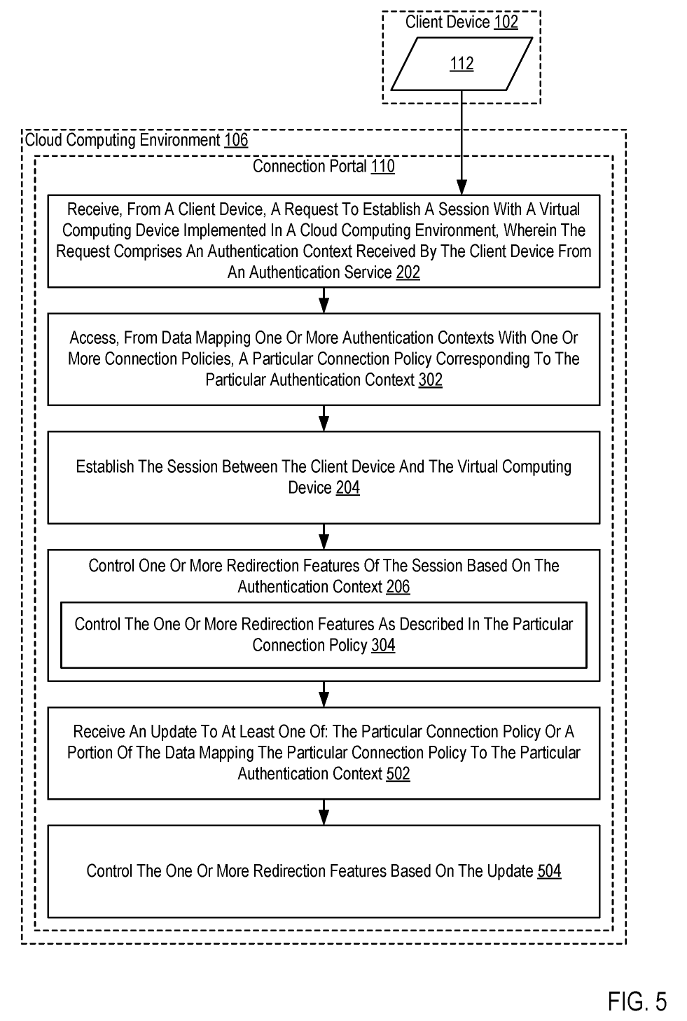

For further explanation, FIG. 5 sets forth a flowchart of another example method of context-based connection policies for securing remote virtual device connections in accordance with some embodiments of the present disclosure. The method of FIG. 5 is similar to FIG. 3, differing in that the method of FIG. 5 also includes: receiving 502 an update to at least one of: the particular connection policy 114 or a portion of the data mapping the particular connection policy 114 to the particular authentication context 112. In some embodiments, the update may be received from an administrator or another user authorized to update connection policies 114 and/or mappings between connection policies 114 and authentication contexts 112.

In some embodiments, the update includes an update to the particular connection policy 114 mapped to the particular authentication context 112 received 202 from the client device 102. For example, the update may change which redirection features are allowed and/or forbidden under the particular authentication context 112. In some embodiments, the update includes an update to a portion of the data mapping the particular connection policy 114 to the particular authentication context 112. For example, the update may change the mapping of the particular authentication context 112 to a different connection policy 114. This different connection policy 114 may include a newly created connection policy 114 or a previously defined connection policy 114.

The method of FIG. 5 also includes controlling 504 the one or more redirection features based on the update. In some embodiments, where the update includes an update to the particular connection policy 114, the one or more redirection features are controlled 504 according to the particular connection policy 114 as updated. In some embodiments, where the update includes an update to a portion of the data mapping the particular connection policy 114 to the particular authentication context 112, the one or more redirection features are controlled 504 based on the different connection policy 114 mapped to the particular authentication context 112 according to the update. Thus, client device(s) 102 connected to virtual computing device(s) 104 with the particular authentication context 112 will have redirection features controlled 504 according to the update. This may include, for example, client devices 102 with an established 204 session having the particular authentication context 112 or sessions established after the update and having the particular authentication context 112. Readers will appreciate that this enables changing how redirection features are controlled without reprovisioning virtual computing devices 104 or updating the client device 102 configuration through remote device management.

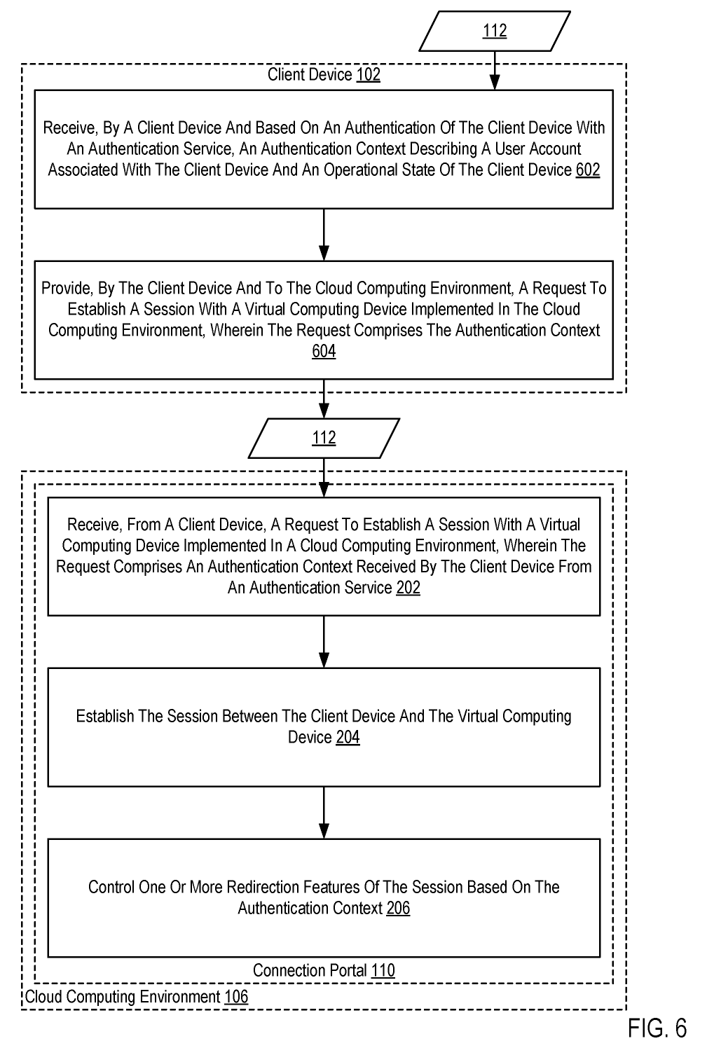

For further explanation, FIG. 6 sets forth a flowchart of another example method of context-based connection policies for securing remote virtual device connections in accordance with some embodiments of the present disclosure. The method of FIG. 6 is similar to FIG. 2, differing in that the method of FIG. 6 also includes receiving 602, by a client device 102 and based on an authentication of the client device 102 with an authentication service 108, an authentication context 112 describing a user account associated with the client device 102 and an operational state of the client device 102. As is set forth above, the authentication context 112 includes data received from the authentication service 108 in response to a successful authentication of the client device 102. This authentication context 112 may be included with or serve as data indicating a successful authentication of the client device 102.

In some embodiments, the authentication context 112 describes a user account associated with the client device 102 in that the authentication context 112 identifies a specific user account logged into the client device 102 or whose authentication credentials were authenticated by the authentication service 108. In some embodiments, the authentication context 112 describes a user account associated with the client device 102 in that the authentication context 112 identifies one or more user groups including such a user account. This allows for redirection features to be controlled 206 based on the particular user account or user group associated with the client device 102.

In some embodiments, the authentication context 112 describes an operational state of the client device 102 in that the authentication context 112 indicates whether the client device 102 is connected to a trusted network. In some embodiments, the authentication context 112 describes an operational state of the client device 102 in that the authentication context 112 indicates whether the client device 102 is a managed device. This allows for redirection features to be controlled 206 based on whether the client device 102 is managed and/or connected to a trusted network, thereby serving as additional dimensions for the authentication context 112 in addition to the user account and/or user group as described above.

The method of FIG. 6 also includes providing 604, by the client device 102 and to a cloud computing environment 106, a request to establish a session with a virtual computing device 104 implemented in the cloud computing environment 106, wherein the request comprises the authentication context 112. In some embodiments, the authentication context 112 is provided 604 to the cloud computing environment 106 (e.g., a connection portal 110) with additional data such as a token indicating successful authentication of the client device 102. In some embodiments, the authentication context 112 itself serves as data indicating successful authentication of the client device 102. Thus, in response to receiving 202 this request, the cloud computing environment 106 is informed that the client device 102 has been successfully authentication and that a session can be established with the virtual computing device 104. The authentication context 112 included in the request may then serve to indicate how the redirection features of the session will be controlled 206 (e.g., as defined in a connection policy 114 mapped to the authentication context 112).

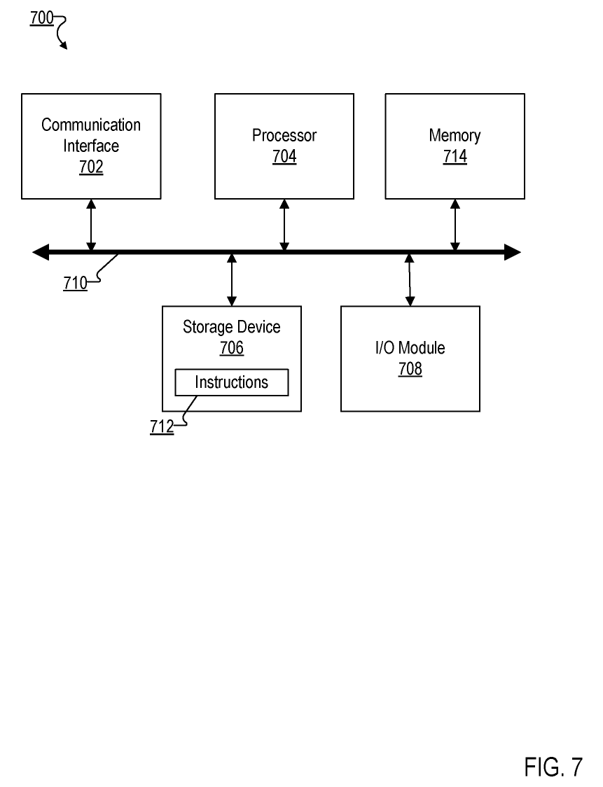

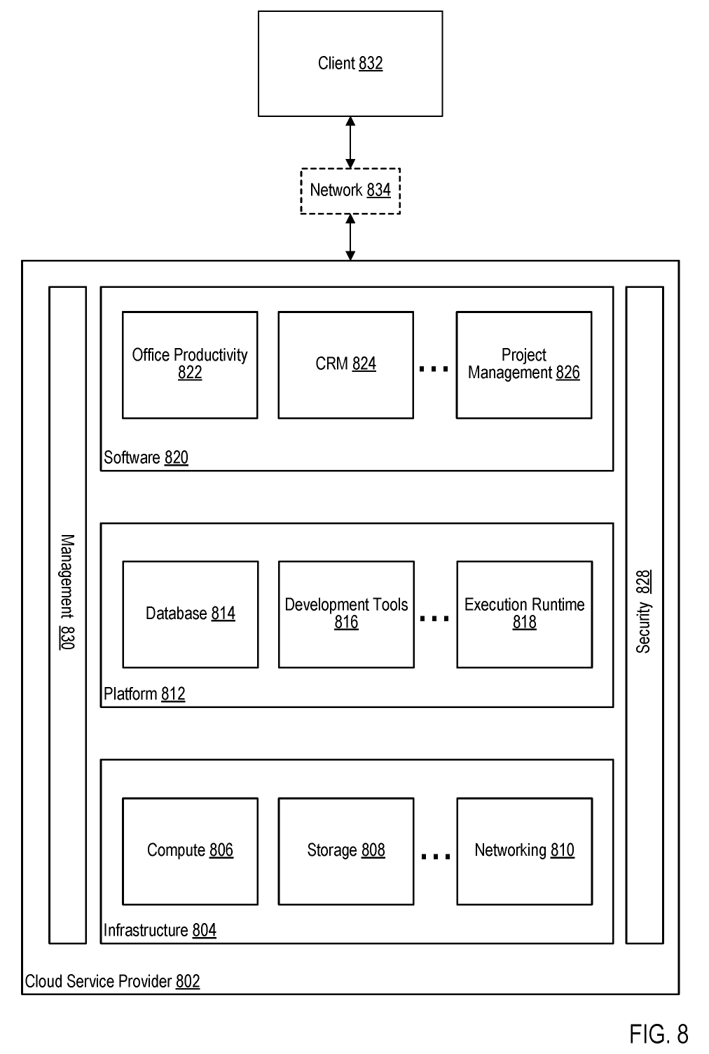

For further explanation, the sections included below provide some details regarding technologies that may be used to support context-based connection policies for securing remote virtual device connections in accordance with some embodiments. For example, FIG. 7 sets forth an example of a computing device that may be used for some portion of securing an operating system in accordance with some embodiments. As an additional example of technologies that may be used to support context-based connection policies for securing remote virtual device connections, FIG. 8 sets forth a block diagram of a cloud service provider 802 service architecture in accordance with some embodiments of the present disclosure.

For further explanation, FIG. 7 illustrates an exemplary computing device 700 that may be specifically configured to perform one or more of the processes described herein. As shown in FIG. 7, computing device 700 may include a communication interface 702, a processor 704, a storage device 706, an input/output (I/O) module 708, and computer memory 714 communicatively connected one to another via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of non-volatile media and/or volatile media. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 700.

For further explanation and as an additional example of a supporting technology for context-based connection policies for securing remote virtual device connections, FIG. 8 sets forth a block diagram of a cloud service provider service architecture in accordance with some embodiments. The cloud service provider 802 can deliver a variety of resources through a services-based consumption model where resources are consumed on-demand and as-a-service. Cloud service providers can provide services via cloud platforms such as, for example, Microsoft Azure^{TM}, Amazon Web Services (‘AWS’)^{TM}, Google Cloud Platform (‘GCP’)^{TM}, and others. In FIG. 8, the cloud service provider 802 is accessed from a client device 834 via a network 832.

FIG. 8 depicts an embodiment where software 820 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 8, as examples of software 820 that can be delivered as-a-service, the illustrated embodiment includes office productivity 822 software, customer relationship management (‘CRM’) 824 software, and project management 826 software. The office productivity 822 software can include applications designed to facilitate common business and personal tasks, including word processing applications, applications for spreadsheet creation, presentation design applications, and many others. The CRM 824 software can include applications for managing a business organization’s relationships and interactions with customers and potential customers. The project management 826 software can include applications designed to help teams plan, organize, and manage projects efficiently by facilitating collaboration and tracking the progress of projects. Readers will appreciate that in other embodiments, other types of software may be delivered using a SaaS model.

FIG. 8 depicts an embodiment where platforms 812 can be delivered as a service. Platform-as-a-service (‘PaaS’) is a model that provides cloud customers with platform resources that they can use to develop, run, and manage applications without the complexity of such deploying and managing such infrastructure on their own. In FIG. 8, as examples of platform 812 resources that can be delivered as-a-service, the illustrated embodiment includes database 814 services, development tools 816 services, and execution runtime 818 services. The database 814 services can be used to provide access to databases without management overhead for the user as the cloud service provider manages the provisioning, scaling, and maintenance of the databases. The development tools 816 services can provide developers with tools to design, develop, test, and deploy applications without needing to manage the underlying infrastructure. The execution runtime 818 services can provide environments where applications or other forms of computer program code can be executed, including services to scale the execution environment. Readers will appreciate that in other embodiments, other platform resources may be delivered using a PaaS model.

FIG. 8 depicts an embodiment where infrastructure 804 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 8, as examples of infrastructure 804 resources that can be delivered as-a-service, the illustrated embodiment includes compute 806 services, storage 808 services, and networking 810 services. The compute 806 services can be used to provide on-demand access to computational resources such as VMs, containers, and serverless functions, where the cloud service provider manages the provisioning, scaling, and maintenance of such resources. The storage 808 services can provide storage resources that can be used to store and access data, without the need for customers to purchase and manage on-premises physical storage resources. The networking 810 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud service provider of FIG. 8 also provides management 830 resources. The management 830 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 8 also provides security 828 resources. The security 828 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:
1. A method of context-based connection policies for securing remote virtual device connections, comprising: receiving, from a client device, a request to establish a session with a virtual computing device implemented in a cloud computing environment, wherein the request comprises an authentication context received by the client device from an authentication service, wherein the authentication context describes a user account associated with the client device and an operational state of the client device; establishing the session between the client device and the virtual computing device; and controlling one or more redirection features of the session based on the authentication context.
2. The method of statement 1, wherein the operational state describes at least one of: whether the client device is a managed device and whether the client device is connected to a trusted network connection.
3. The method of statements 1 or 2, wherein the authentication context comprises a particular authentication context of one or more authentication contexts, and the method further comprises: accessing, from data mapping the one or more authentication contexts with one or more connection policies, a particular connection policy corresponding to the particular authentication context; and wherein controlling the one or more redirection features comprises controlling the one or more redirection features as described in the particular connection policy.
4. The method of any combination of one or more of statements 1-3, wherein the authentication service is configured to authenticate the client device by selecting the particular authentication context from the one or more authentication contexts.
5. The method of any combination of one or more of statements 1-4, wherein controlling the one or more redirection features as described in the particular connection policy comprises applying one or more default redirection feature restrictions.
6. The method of any combination of one or more of statements 1-5, further comprising: receiving an update to at least one of: the particular connection policy or a portion of the data mapping the particular connection policy to the particular authentication context; and controlling the one or more redirection features based on the update.
7. The method of any combination of one or more of statements 1-6, wherein the one or more redirection features comprise at least one of: clipboard redirection, print redirection, or file redirection.
8. A method of context-based connection policies for securing remote virtual device connections, comprising: receiving, by a client device and based on an authentication of the client device with an authentication service, an authentication context describing a user account associated with the client device and an operational state of the client device; providing, by the client device and to a cloud computing environment, a request to establish a session with a virtual computing device implemented in the cloud computing environment, wherein the request comprises the authentication context; and establishing the session with the virtual computing device, wherein the cloud computing environment is configured to control one or more redirection features of the session based on the authentication context.
9. The method of statement 8, wherein the operational state describes at least one of: whether the client device is a managed device and whether the client device is connected to a trusted network connection.
10. The method of statements 8 or 9, wherein the cloud computing environment is configured to control the one or more redirection features by accessing data mapping one or more authentication contexts to one or more connection policies defining restrictions for the one or more redirection features.
11. The method of any combination of one or more of statements 8-10, wherein the authentication service is configured to authenticate the client device by selecting the authentication context from the one or more authentication contexts.
12. The method of any combination of one or more of statements 8-11, wherein the one or more authentication contexts and the one or more connection policies are administrator-defined.
13. The method of any combination of one or more of statements 8-12, wherein the one or more redirection features comprise at least one of: clipboard redirection, print redirection, or file redirection.
14. An apparatus for context-based connection policies for securing remote virtual device connections, comprising: a memory; and one or more processing devices, operatively coupled to the memory, the one or more processing devices configured to: receiving, from a client device, a request to establish a session with a virtual computing device implemented in a cloud computing environment, wherein the request comprises an authentication context received by the client device from an authentication service, wherein the authentication context describes a user account associated with the client device and an operational state of the client device; establishing the session between the client device and the virtual computing device; and controlling one or more redirection features of the session based on the authentication context.
15. The apparatus of statement 14, wherein the operational state describes at least one of: whether the client device is a managed device and whether the client device is connected to a trusted network connection.
16. The apparatus of statements 14 or 15, wherein the authentication context comprises a particular authentication context of one or more authentication contexts, and wherein the one or more processing devices are further configured to: access, from data mapping the one or more authentication contexts with one or more connection policies, a particular connection policy corresponding to the particular authentication context; and wherein, to control the one or more redirection features, the one or more processing devices are further configured to control the one or more redirection features as described in the particular connection policy.
17. The apparatus of any combination of one or more of statements 14-16, wherein the authentication service is configured to authenticate the client device by selecting the particular authentication context from the one or more authentication contexts.
18. The apparatus of any combination of one or more of statements 14-17, wherein, to control the one or more redirection features as described in the particular connection policy, the one or more processing devices are further configured to apply one or more default redirection feature restrictions.
19. The apparatus of any combination of one or more of statements 14-18, wherein the one or more processing devices are further configured to: receive an update to at least one of: the particular connection policy or a portion of the data mapping the particular connection policy to the particular authentication context; and control the one or more redirection features based on the update.
20. The apparatus of claim 14, wherein the one or more redirection features comprise at least one of: clipboard redirection, print redirection, or file redirection.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory ("RAM"), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method of securing a remote virtual computing device connection, comprising:
receiving, from a client device, a request to establish a session with a virtual computing device implemented in a cloud computing environment, wherein the request comprises an authentication context received by the client device from an authentication service, wherein the authentication context describes a user account associated with the client device and an operational state of the client device;
establishing the session between the client device and the virtual computing device; and
controlling one or more redirection features of the session based on the authentication context.

2. The method of claim 1, wherein the operational state describes at least one of: whether the client device is a managed device and whether the client device is connected to a trusted network connection.

3. The method of claim 1, wherein the authentication context comprises a particular authentication context of one or more authentication contexts, and the method further comprises:
accessing, from data mapping the one or more authentication contexts with one or more connection policies, a particular connection policy corresponding to the particular authentication context; and
wherein controlling the one or more redirection features comprises controlling the one or more redirection features as described in the particular connection policy.

4. The method of claim 3, wherein the authentication service is configured to authenticate the client device by selecting the particular authentication context from the one or more authentication contexts.

5. The method of claim 3, wherein controlling the one or more redirection features as described in the particular connection policy comprises applying one or more default redirection feature restrictions.

6. The method of claim 3, further comprising:
receiving an update to at least one of: the particular connection policy or a portion of the data mapping the particular connection policy to the particular authentication context; and
controlling the one or more redirection features based on the update.

7. The method of claim 1, wherein the one or more redirection features comprise at least one of: clipboard redirection, print redirection, or file redirection.

8. A method of securing a remote virtual computing device connection, comprising:
receiving, by a client device and based on an authentication of the client device with an authentication service, an authentication context describing a user account associated with the client device and an operational state of the client device;
providing, by the client device and to a cloud computing environment, a request to establish a session with a virtual computing device implemented in the cloud computing environment, wherein the request comprises the authentication context; and
establishing the session with the virtual computing device, wherein the cloud computing environment is configured to control one or more redirection features of the session based on the authentication context.

9. The method of claim 8, wherein the operational state describes at least one of: whether the client device is a managed device and whether the client device is connected to a trusted network connection.

10. The method of claim 8, wherein the cloud computing environment is configured to control the one or more redirection features by accessing data mapping one or more authentication contexts to one or more connection policies defining restrictions for the one or more redirection features.

11. The method of claim 10, wherein the authentication service is configured to authenticate the client device by selecting the authentication context from the one or more authentication contexts.

12. The method of claim 10, wherein the one or more authentication contexts and the one or more connection policies are administrator-defined.

13. The method of claim 8, wherein the one or more redirection features comprise at least one of: clipboard redirection, print redirection, or file redirection.

14. An apparatus for securing a remote virtual computing device connection, comprising:
a memory; and
one or more processing devices, operatively coupled to the memory, the one or more processing devices configured to:
receiving, from a client device, a request to establish a session with a virtual computing device implemented in a cloud computing environment, wherein the request comprises an authentication context received by the client device from an authentication service, wherein the authentication context describes a user account associated with the client device and an operational state of the client device;
establishing the session between the client device and the virtual computing device; and
controlling one or more redirection features of the session based on the authentication context.

15. The apparatus of claim 14, wherein the operational state describes at least one of: whether the client device is a managed device and whether the client device is connected to a trusted network connection.

16. The apparatus of claim 14, wherein the authentication context comprises a particular authentication context of one or more authentication contexts, and wherein the one or more processing devices are further configured to:
access, from data mapping the one or more authentication contexts with one or more connection policies, a particular connection policy corresponding to the particular authentication context; and
wherein, to control the one or more redirection features, the one or more processing devices are further configured to control the one or more redirection features as described in the particular connection policy.

17. The apparatus of claim 16, wherein the authentication service is configured to authenticate the client device by selecting the particular authentication context from the one or more authentication contexts.

18. The apparatus of claim 16, wherein, to control the one or more redirection features as described in the particular connection policy, the one or more processing devices are further configured to apply one or more default redirection feature restrictions.

19. The apparatus of claim 16, wherein the one or more processing devices are further configured to:
receive an update to at least one of: the particular connection policy or a portion of the data mapping the particular connection policy to the particular authentication context; and
control the one or more redirection features based on the update.

20. The apparatus of claim 14, wherein the one or more redirection features comprise at least one of: clipboard redirection, print redirection, or file redirection.
